(19) United States
(12) Patent Application Publication
(10) Pub. No.: US 2007/0048695 A1
(43) Pub. Date: Mar. 1, 2007

(54) Interactive scoring system for learning language

(76) Inventor: Wen-Chen Huang, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/214,718

(22) Filed: Aug. 31, 2005

(51) Int. Cl. G09B 19/00

(52) U.S. Cl. 434/156

(57) ABSTRACT

The present invention relates to an interactive scoring system for learning a language, in which a means such as a web camera is used to capture the learner's lip images and then a score is given by comparing with images stored in the database. The images stored in the database are previously recorded by a teacher. By means of the scoring system, the learner can rectify and improve pronunciation concerning features of the lip and tongue.

### BACKGROUND OF THE INVENTION

1. Field of the Invention

The present invention relates to an interactive scoring system for learning a language, and particularly to an interactive scoring system for learning a language by comparing a learner's lip images with a teacher's.

2. Related Prior Arts

Currently, digital tools for learning languages are very popular to students and workers. Some of the tools even provide figured interfaces for users to conveniently operate and practice in listening, speaking, reading and writing, for example, computer aided design (CAD) or computer assisted instruction (CAI). However, most of the tools for practicing speaking are not efficient as only real voice or demonstration films are provided without feedback for the learner's practicing. Moreover, learning languages by listening is unfeasible for the deaf.

The similar problems occur in asynchronous on-line courses, in which audio-video information is sent to learners for practicing. The learners hardly find errors in pronunciation and syllables by distinguishing differences between their lip features and teachers'. Also the deaf could not utilize such tools to learn a language.

Therefore, it's still difficult to evaluate the learners' grades in speaking a language. The following techniques are developed by some researchers.

In Jun-Yi Lee et al.'s speech evaluation, three types of speech characteristics, i.e., magnitude, pitch contour and Mel-Frequency Cepstral coefficients, are evaluated by dynamic time warping (DTW) and Hidden Markov Model (HMM). As a result, Mel-Frequency Cepstral coefficients show the highest relationship, pitch contour shows less, and magnitude shows the least.

In Su-Hui Liao's research about speech practicing, the main activities should include syllables associated with Pin-Yin and accent, rhythm, students' speech and recognition in pronunciation types.

In Jen-Yu Jian's investigation about recognition of lip shapes, lip contours for different vowels pronounced by different people are statistically analyzed. According to the results of statistics, several recognizable parameters are selected to establish a classification tree for a single vowel. The modified one-dimension fast Hartley transform provides a structural analysis of lip contours, and the test results indicate that recognition ratios of single vowel with this classification tree are 95% for trained testees and 85% for untrained testees.

On the other hand, the bimodal audio-visual system is developed. Matthews et al. provide a recognition method for reading lip according to visual features. Three parameters representing consecutive lip contours are adapted and analyzed with Hidden Markov Model (HMM). Silsbee and Bouik provide other solutions in researching lip-reading with lip features, for example, contour-based and image-based. In the contour-based process, edge information, deformable templates or active contour are used to find the features which can be still preserved after translation, rotation, scaling and different illumination. However, much useful information may be omitted in this method, for example, features of teeth and tongues. The image-based process includes principal component analysis, wavelet and fast Fourier transform (FFT), which describe the consecutive lip images with less information.

The automatic speech recognizer (ASR) provides a function of distinguishing end user's speech. However, the ASR system is usually annoyed by ambient noises and thus accuracy thereof is lowered. Shu-Hung Leung et al. provide another solution, in which an area covering the lip is selected according to Elliptic Shape Function and FUZZY C-MEANS. Shu-Hung Leung et al. also apply this technique to determine the lip contours on consecutive RGB images by dividing the lips into several parts, then finding the lip features and recognizing with Hidden Markov Model.

### SUMMARY OF THE INVENTION

An object of the present invention is to provide an interactive scoring system for learning a language, which can evaluate a learner's speech according to his lip and tongue features.

To achieve the above object, the scoring system basically comprises an image capturing means for capturing a teacher's lip images or a learner's lip images; a database for storing the teacher's lip images and corresponding word(s); and a scoring mechanism for determining the learner's score by comparing the learner's lip images with those of the same word(s) stored in the database.

The image capturing means used in the system can be a web camera or other equipment suitable for the same purpose.

To facilitate comparison, the images can be previously unified in size and/or number before comparison, for example, by deleting one of the images having the least difference.

The learner's score can be a sum of differences between the learner's images and the images of the same word(s) stored in the database; alternatively, determined according to a dynamic time warping (DTW) process.

The interactive scoring system can also further comprise a judging mechanism for judging whether the word(s) to be inputted has existed in the database.

Accordingly, the scoring system of the present invention can provide the language learner a tool to understand differences between his lip features and the teacher's when speaking the same word(s), and thus rectify the learner's pronunciation.

### BRIEF DESCRIPTION OF THE DRAWINGS

FIG. 1 shows the main components of the scoring system and their relationships in operation;

FIG. 2 is a flow chart of the scoring system.

### DETAILED DESCRIPTION OF THE PREFERRED EMBODIMENTS

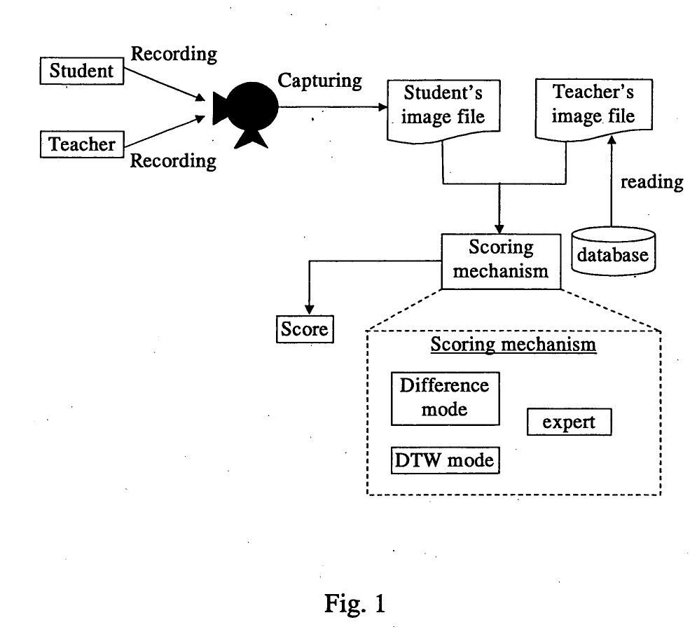

FIG. 1 shows main components of a scoring system and their relationships in operation. As shown in the figure, a learner, a teacher, a database and a scoring mechanism are involved in the system.

The learner can first select a word (hereinafter including a letter or a sentence) for practicing, and a web camera provided with the system captures consecutive images of the learner's lip. Then appropriate areas covering the learner's lip will be determined by moving a frame shown on a display or suitable media.

Prior to being used by the learner, the teacher can input characters of a word by typing and corresponding lip images captured by the web camera, if the same word do not exist in the database. These data will be stored in the database for comparison and this procedure can be repeated. The words and lip images stored in the database are accessible.

The scoring mechanism is to determine a score or grade for the learner's pronunciation by comparing the learner's lip images with the teacher's stored in the database. Accuracy or correction of the learner's pronunciation can be evaluated according to a difference process or a dynamic time warping process.

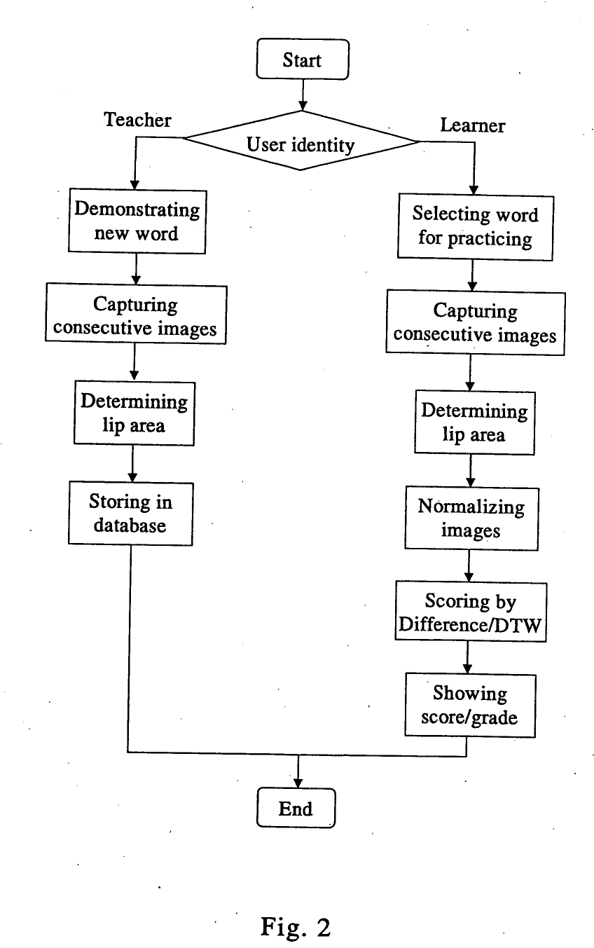

The scores can be further compared with evaluation results from an expert to find the preferred scoring mechanism. FIG. 2 is a flow chart of the system operated by a user, i.e., a learner or a teacher. Through a media such as a dialog window on a display, the teacher can input words in the form of characters and lip images which will be stored in the database. The lip images are captured by the web camera (or WebCam). The teacher's inputting can be repeated until an instruction for stopping is given. Similarly, through a media such as a dialog window, the learner can select a word for practicing and then speak out, so that the lip images can be consecutively captured by the web camera. The images will be further processed for comparison.

The consecutive images in grey-level mode are then presented on the display or other media for the user to determine an area covering the lip by moving a selection frame. The frame can be scaled by inputting a width and a height or directly dragging the frame.

The images covering the lip can be processed through normalization and screening to obtain key images in which the learner's lip contour will be compared with the teacher's by means of difference and dynamic time warping. Result of comparison will be shown as a score or grade and further compared with a score given by the expert.

Normalization is a process for unifying sizes of the teacher's lip and the learner's and Equation (1) is applied.

$${T}_{m} = {T}_{i} \times \frac{{T}_{i}}{{S}_{i}} \qquad ( 1 )$$

wherein Tₘ is the area of the teacher's lip after normalized, Tᵢ is the size of the teacher's ith image, Si is the size of the learner's ith image, Tᵢ/Sᵢ is a ratio for scaling the image.

Screening of the images is a process for unifying numbers of the learner's images and the teacher's by deleting similar images.

In the preferred embodiment of the present invention, two processes, difference and dynamic time warping (DTW), are provided for comparison.

In the difference process, the teacher's images and the learner's images are first normalized according to the above Equation (1). Then the images are screened by deleting one of the images having the least difference according to Equation (2):
dᵢ=|ᵢ−Iᵢ₋₁|, i=1,2,3, . . . n (2)
wherein Iᵢ and Iᵢ₋₁ are respectively the ith image and the (i-1)th image, n is the total number of the images. The procedure of deleting image Iᵢ having the least dᵢ will be repeated until number of the remained images is desired according to Equation (3):

$${\sum }_{k = 0}^{n - b} {\sum }_{i - 1}^{n - k} {d}_{i} = \vert {I}_{i} - {I}_{i - 1} \vert \qquad ( 3 )$$

wherein b is the desired number of the remained images.

After Spatial-temporal analysis, the teacher's and the learner's images are compared and expressed as the teacher's ith image (Tᵢ) minus the learner's ith image (Sᵢ) according to Equation (4):

$${\sum }_{i = 0}^{b} {T}_{i} - {S}_{i} \qquad ( 4 )$$

The difference process is performed as follows:
A. Inputting the teacher's and the learner's images;
B. Determining a desired number of the remained images after normalization, and if the number is larger than the teacher's or the learner's, determine the number is again;
C. Normalizing the teacher's and the learner's lip images;
D. Screening the images by deleting the one having the least dᵢ;
E. Subtracting the learner's images from the teacher's correspondingly;
F. Giving a score for the learner by summating the differences of step E.

Dynamic time warping is a process for identifying word(s) in case of taking different times to speak the same word(s). To evaluate similarity between the teacher's images and the learner's images, a nonlinear path comprising corresponding images and having the least deviation is established. For example, the number of the teacher's images is m, and that of the learner's is n.

The teacher's images are expressed as t(1), t(2), . . . and t(m); and the learner's are expressed as s(1), s(2), . . . and s(n). The dynamic time warping process is to find an optimal path from (1,1) to (m,n) on the m×n matrix. If d(i,j) (=|t(i)−s(j)|) is a distance between t(i) and s(j), the optimal path will be the least distance D(i,j) accumulated from (1,1) to (m,n).

$$D ( i , j ) = min \{ \begin{matrix}D ( i , j - 1 ) + d ( i , j ) \\ D ( i - 1 , j - 1 ) + 2 d ( i , j ) \\ D ( i - 1 , j ) + d ( i , j )\end{matrix} \qquad ( 5 )$$

Once the accumulated distance is found; the optimal path can be established by inversely deducting the least accumulated distance. Other conditions can be used to accelerate calculation of the DTW process, for example, the optimal path c(1), c(2), . . . c(p), c(k)=(t(k), s(k)), 1≦k≦p.
(a) boundary conditions:
   c(1)=(1,1), c(p)=(m,n) (6)
(b) increasing conditions:
   t(k−1)≦t(k)
   s(k−1)≦s(k) (7)
(c) continuity conditions:
   t(k)−t(k−1)≦1
   s(k)−s(k−1)≦1 (8)
(d) window constrain:
   |t(k)−s(k)|≦w, w is a size of the window (9)
(e) slope constraint: moving at least y steps in s-direction after moving x steps in t-direction.

After Spatial-temporal analysis, the images are in grey-level mode ranging from 0 to 255. Therefore, a sum of differences between corresponding pixels of each of the teacher's images and each of the learner's images can be obtained, and the sums of the all images are summated according to Equation (10):

$$E = \frac{{\sum }_{i = 0}^{b} {T}_{i} - {S}_{i}}{K} \qquad ( 10 )$$

wherein Tᵢ is the teacher's ith image, Sᵢ is the learner's ith image, K is the amount of all images, E is an average value of the differences sum.

Scores 0˜100 can be obtained according Equations (11) and (12):
MaxE=W×H×255 (11)

$$Score = 100 - 100 \times \frac{E}{Max E} \qquad ( 12 )$$

wherein MaxE is the maximum difference, W and H are respectively the width and height of the lip image, 100×(E/MaxE) is a difference score, and real score can be obtained by 100 subtracting the difference score.

As described above, the present invention exhibits advantages as follows:
1. The interactive system facilitates learners to practice alone and improve pronunciation by watching lip images and thus rectifying features of lips and tongues.
2. The lip images can help the deaf to speak more accurately as they are mostly difficult in learning language by listening.
3. A novel scoring mechanism for learning languages is developed by comparing lip images between learners and teachers, since features of the lip and tongue are keys to correctly pronouncing.

What is claimed is:

1. An interactive scoring system for learning a language, comprising:
an image capturing means for capturing a teacher's lip images or a learner's lip images;
a database for storing said teacher's lip images and corresponding word(s); and
a scoring mechanism for determining said learner's score by comparing said learner's lip images with those of the same word(s) stored in said database.

2. The interactive scoring system as claimed in claim 1, wherein said image capturing means is a web camera.

3. The interactive scoring system as claimed in claim 1, wherein said images are previously unified in size before comparison.

4. The interactive scoring system as claimed in claim 1, wherein said images are previously unified in number before comparison.

5. The interactive scoring system as claimed in claim 4, wherein said images are previously unified in number by deleting one of the images having the least difference.

6. The interactive scoring system as claimed in claim 1, wherein said learner's score is a sum of differences between said learner's images and said images of the same word(s) stored in said database.

7. The interactive scoring system as claimed in claim 1, wherein said learner's score is determined according to a dynamic time warping (DTW) process.

8. The interactive scoring system as claimed in claim 1, further comprising a judging mechanism for judging whether said word(s) to be inputted has existed in said database.
